(19) United States
(12) Patent Application Publication
(10) Pub. No.: US 2003/0056197 A1
(43) Pub. Date: Mar. 20, 2003

(54) Method and apparatus to facilitate debugging computer code within an operating system kernel

(76) Inventors: Peter D. J. Dennis, Wokingham (GB); Christopher W. Beal, Reading (GB)

Correspondence Address: PARK, VAUGHAN & FLEMING LLP, 508 SECOND STREET, SUITE 201, DAVIS, CA, 95616, US

(21) Appl. No.: 09/944,311

(22) Filed: Aug. 30, 2001

(51) Int. Cl. G06F 9/44

(52) U.S. Cl. 717/126

(57) ABSTRACT

One embodiment of the present invention provides a system that facilitates debugging computer code within an operating system kernel. The system operates by first receiving a source file containing a data structure definition. The system searches the source file for the data structure definition and, upon finding the data structure definition, saves the data structure definition in a storage structure. Next, the system generates source code to display the data structure using the data structure definition. The system then compiles the source code into an executable module and installs the executable module into a modular debugger. During execution of the modular debugger, the executable module displays the content of the data structure to a user of the modular debugger.

### BACKGROUND

1. Field of the Invention

The present invention relates to computer code. More specifically, the present invention relates to a method and an apparatus that facilitates debugging computer code within an operating system kernel.

2. Related Art

Computer systems typically include an operating system, which coordinates the operations performed by the computer system. These operations include: scheduling tasks, providing peripheral services, handling external interrupts, and the like.

These operating systems, like most computer code, need to be tested and debugged in order to provide error-free services to a user. However, by their very nature, operating systems are notoriously difficult to debug. This difficulty arises because a debugger, like any executing program, relies on the services of the operating system. Therefore, operations like single-stepping the code are simply not available. Also, many operating systems are not re-entrant, which prevents debugging a service which relies upon itself to provide that service to the debugger. Additionally, if the operating system has defects, the defect itself may prevent its discovery.

In an effort to provide debugging capabilities for the operating system kernel, engineers have created a modular debugger, which can facilitate debugging the operating system kernel. In operation, the operator, or other person debugging the operating system, writes source code, which is custom designed to gather data for the data structures within the operating system. This gathered data can then be saved in the computer system's memory until such time as the operating system, or another custom software program, can display or print the gathered data.

While this is an effective method for debugging the code for the operating system kernel, it is a slow and tedious process. The operator first examines the source files of the operating system kernel to determine the data structures within the kernel. Next, the operator writes source code to create a module for the modular debugger. This module is designed to gather data from the kernel's data structures during execution of the operating system kernel.

After creating this source code, the operator compiles the source code into an executable module, which is then inserted into the modular debugger to gather data from the data structures within the kernel while the kernel is executing. Since the source code for this module is hand written, the module may also contain errors, which need to be discovered and fixed to provide meaningful results to the operator.

What is needed is a method and an apparatus to facilitate debugging computer code within an operating system kernel, which does not have the problems listed above.

### SUMMARY

One embodiment of the present invention provides a system that facilitates debugging computer code within an operating system kernel. The system operates by first receiving a source file containing a data structure definition. The system searches the source file for the data structure definition and, upon finding the data structure definition, saves the data structure definition in a storage structure. Next, the system generates source code to display the data structure using the data structure definition. The system then compiles the source code into an executable module and installs the executable module into a modular debugger. During execution of the modular debugger, the executable module displays the content of the data structure to a user of the modular debugger.

In one embodiment of the present invention, receiving the source file includes receiving more than one source file.

In one embodiment of the present invention, the source file contains more than one data structure.

In one embodiment of the present invention, saving the data structure definition in the storage structure includes saving the more than one data structure in the storage structure.

In one embodiment of the present invention, generating the new source code includes examining all of the data structures in the storage structure to locate cross-references between data structures and generating source code to gather and display data from all of the data structures.

In one embodiment of the present invention, generating the new source code includes generating source code to walk a linked list of data structures.

In one embodiment of the present invention, displaying the content of the data structure includes displaying the content of the linked list of data structures.

In one embodiment of the present invention, the data structure definition includes, but is not limited to, trees, linked lists, doubly linked lists, and queues.

### BRIEF DESCRIPTION OF THE FIGURES

FIG. 1 illustrates computer 104 in accordance with an embodiment of the present invention.

FIG. 2 illustrates computer 202 in accordance with an embodiment of the present invention.

FIG. 3 is a flowchart illustrating the process of placing data structure definitions in a storage structure in accordance with an embodiment of the present invention.

FIG. 4 is a flowchart illustrating the process of generating source code for data structure definitions in accordance with an embodiment of the present invention.

FIG. 5 is a flowchart illustrating the process of using modules generated from data structure definitions to debug an operating system kernel in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Code Generation Computer

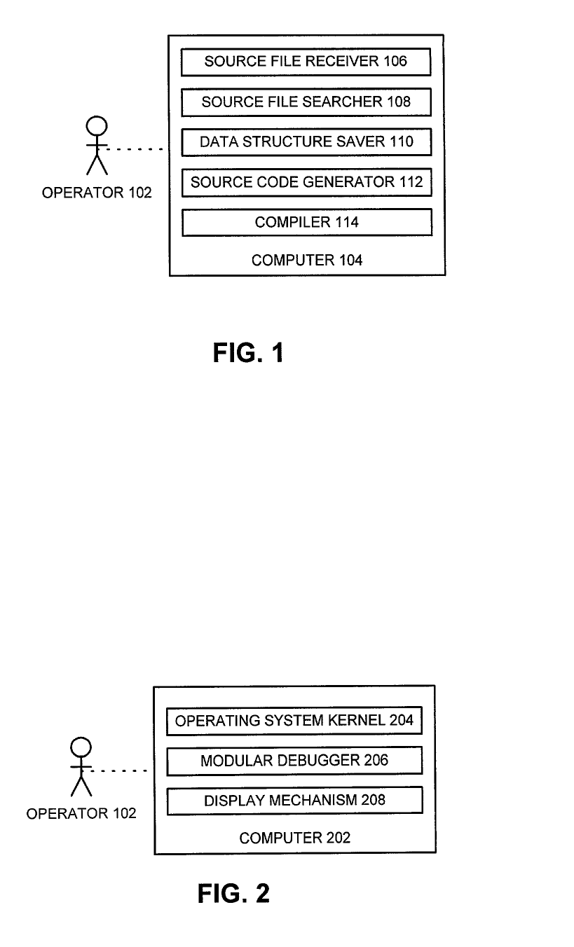

FIG. 1 illustrates computer 104 in accordance with an embodiment of the present invention. Computer 104 can generally include any type of computer system, including, but not limited to, a computer system based on a microprocessor, a mainframe computer, a digital signal processor, a portable computing device, a personal organizer, a device controller, and a computational engine within an appliance.

Computer 104 includes source file receiver 106, source file searcher 108, data structure saver 110, source code generator 112, and compiler 114. Operator 102 interacts with computer 104 to generate executable modules for modular debugger 206 (see FIG. 2) for debugging operating system kernel 204.

Source file receiver 106 receives source files containing data structure definitions. Examples of these source files include header files written in the C programming language. The data structure definitions in C header files include structures defined with the C keywords struct, enum, typedef, and union. The keywords for data structure definitions in other programming languages are dependent upon the language being used.

Source file searcher 108 examines the contents of each source file received by source file receiver 106 to locate data structure definitions identified by these language specific keywords. Upon finding a language specific keyword, source file searcher 108 causes data structure saver 110 to save the data structure definition in a storage structure. Note that saving the data structure definition in the storage structure includes saving a pointer to the data structure definition in the storage structure. In one embodiment of the present invention, the storage structure is a tree.

After source code searcher has identified the data structure definitions in the source files and stored these data structure definitions in the storage structure, source code generator 112 scans the storage structure to locate cross-references among the data storage definitions. Then source code generator 112 generates source code for a module compatible with modular debugger 206. This source code, when compiled into an executable module, can be used by modular debugger 206 to display the various data structures. Source code generator 112 can also generate source code files, which can be used to walk down a linked list using one of the elements within the data structure definition as the address of the next node in the list.

Compiler 114 compiles the source code modules generated by source code generator 112 to provide executable modules, which can be used by modular debugger 206.

Computer System

FIG. 2 illustrates computer 202 in accordance with an embodiment of the present invention. Computer 202 can generally include any type of computer system, including, but not limited to, a computer system based on a microprocessor, a mainframe computer, a digital signal processor, a portable computing device, a personal organizer, a device controller, and a computational engine within an appliance.

Computer 202 includes operating system kernel 204, modular debugger 206, and display mechanism 208. In this embodiment of the present invention, operator 102 is debugging operating system kernel 204.

Operator 102 causes modular debugger 206 to load and execute the executable modules created by compiler 114. These executable modules access and display the contents of the various data structures located by source file searcher 108. In addition, these executable modules walk through data structures that have been identified as linked lists to display the structures in the list until a terminating condition-for example, a NULL pointer-is encountered.

Display mechanism 208 displays the output data from the executable modules to operator 102. Operator 102 can then analyze the displayed data and determine the correctness of operation of operating system kernel 204, and can determine how to proceed if operating system kernel 204 is providing incorrect results.

Building the Data Structure

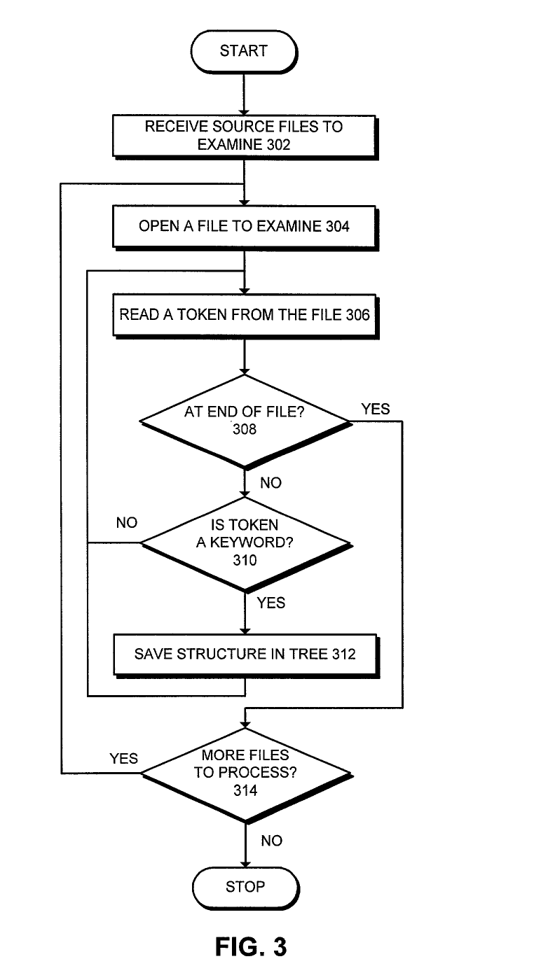

FIG. 3 is a flowchart illustrating the process of placing data structure definitions in a storage structure in accordance with an embodiment of the present invention. The system starts when source file receiver 106 in computer 104 receives source files to examine for data structure definitions (step 302).

Next, source file searcher 108 opens a source file to be examined (step 304). After opening the source file, source file searcher 108 attempts to read a token from the source file (step 306).

Source file searcher 108 then determines if the end-of-file has been reached (step 308). Note that source file searcher 108 can determine if the end-of-file has been reached by determining if the attempt to read a token has been successful. If a token has been read, the end-of-file has not been reached.

If a token has been read from the source file, source file searcher 108 determines if the token is a language specific keyword denoting a data structure definition (step 310). If the token is a keyword denoting a data structure definition, data structure saver 110 saves the data structure definition, or a pointer to the data structure definition, in a storage structure (step 312). In one implementation of the present invention, this storage structure is a tree.

If the token is not a data structure definition at 310, or after saving the storage structure at 312, the process returns to 306 to read the next token.

If the end-of-file has been reached at 308, source file searcher 108 determines if there are more files to examine (step 314). If there are more files to examine, the process returns to 304 to open the next file, otherwise, the process is ended.

Generating Source Code

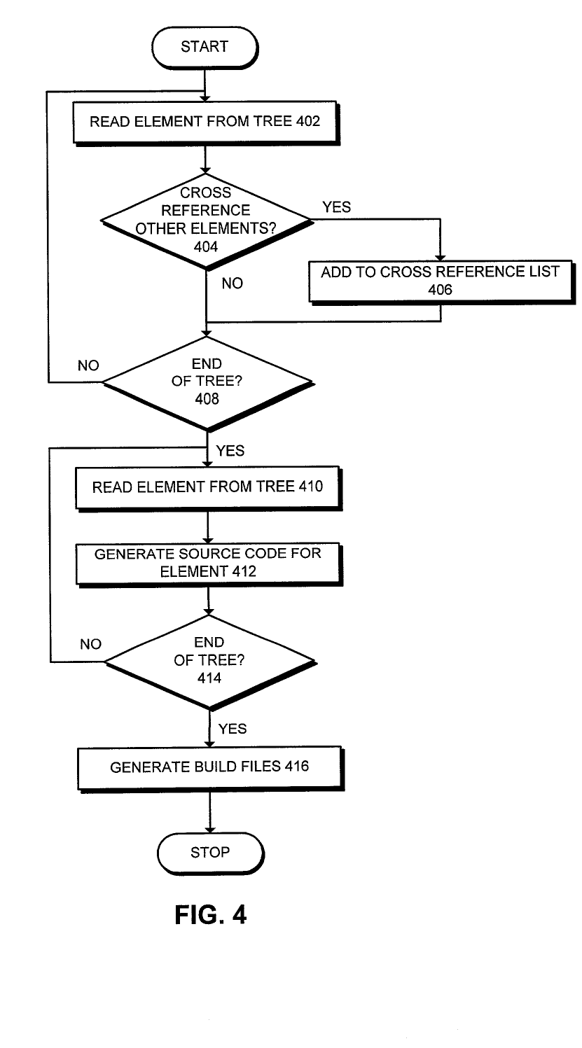

FIG. 4 is a flowchart illustrating the process of generating source code for data structure definitions in accordance with an embodiment of the present invention. The system starts when source code generator 112 reads a data structure definition, or element, from the storage structure (step 402). Next, source code generator 112 determines if the data structure definition cross-references any other data structure definitions (step 404).

If the data structure definition cross-references any other data structure definitions, source code generator 112 saves the cross-reference data in a cross-reference list (step 406). If the data structure definition does not cross-reference any other data structure definitions at 404 or after saving the cross- reference data at 406, source code generator 112 determines if the end-of-tree has been reached (step 408). If end-of-tree has not been reached, the process returns to step 402 to read the next element in the storage structure.

If the end-of-tree has been reached at 408, source code generator 112 returns to the beginning of the storage structure and reads an element from the storage structure (step 410). Next, source code generator 112 generates source code, which, when compiled to an executable module and executed within modular debugger 206, will display the contents of the data structure from operating system kernel 204 (step 412).

After generating the source code for the element, source code generator 112 determines if the end-of-tree has been reached (step 414). If not, the process returns to 410 to continue generating source code for the elements in the storage structure.

When the end-of-tree has been reached at 414, source code generator 112 generates the build files which will allow compiler 114 to generate the executable modules from the source code modules (step 416).

Debugging the Operating System Kernel

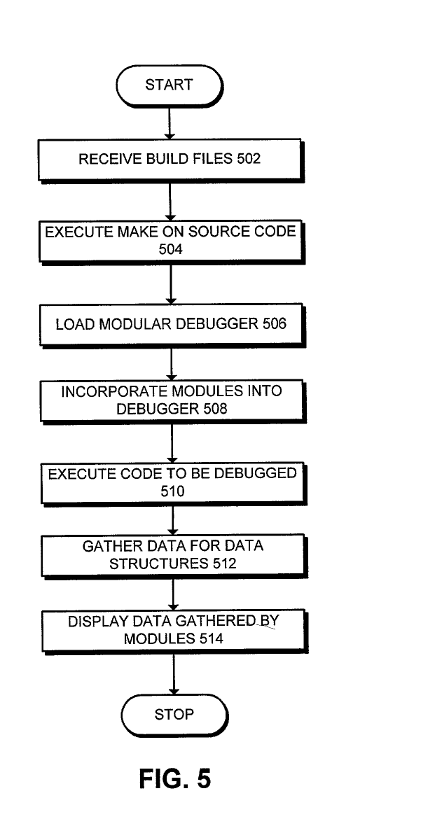

FIG. 5 is a flowchart illustrating the process of using modules generated from data structure definitions to debug an operating system kernel in accordance with an embodiment of the present invention. The system starts when compiler 114 receives build files generated by source code generator 112 (step 502). These build files, and the associated source code files, include instructions to generate executable modules for modular debugger 206 which can be used to display the data structures as described above.

Next, compiler 114 executes the make files to generate the executable modules from the source code modules (step 504). After the executable modules have been created by compiler 114, operator 102 loads modular debugger 206 on computer 202 (step 506). Next, operator 102 incorporates these executable modules into modular debugger 206 (step 508).

Modular debugger 206 then executes the code within operating system kernel 204 (step 510). The executable modules incorporated into modular debugger 206 then gather data for the data structures within operating system kernel 204 (step 512). Finally, display mechanism 208 displays the data gathered by the executable modules so that operator 102 can determine the operating condition of operating system kernel 204 (step 514).

### EXAMPLES

Assume that the computer program incorporating the processes of placing data structure definitions in a storage structure and subsequently generating source code for these data structure definitions is labeled mdbgen, and further assume that the C header files /usr/include/sys/vnode.h and /usr/include/vm/page.h includes the following structures:

struct vnodeops_t,

struct async_reqs,

struct vsecaftr_t,

struct page_t,

struct vattr32_t

struct vattr_t, and

struct vnode_t.

Executing the command

mdbgen -f /usr/include/sys/vnode.h, /usr/include/vm/page.h

where -f flags the file names will generate the following source code files:

struct_vnodeops_t.c,

struct_async_reqs.c,

struct_vsecattr_t.c,

struct_page_t.c,

struct_vattr32_t.c,

struct_vattr_t.c, and

struct_vnode_t.

After compiling these source modules, the resultant code can be executed by the modular debugger (mdb).

During operation of mdb, the command:

30000231e58::struct_vnode_t

will display the vnode_t structure located at address 30000231e58. A possible output of this command is:

| | |
|---|---|
| v_lock: | 0 |
| v_flag: | 1 |
| v_count: | 0x51 |
| v_vfsmoundedhere: | 0 |
| v_op: | 0x104609f8 |
| v_vfsp: | 0x1043f4e0 |
| v_stream: | 0 |
| v_pages: | 0x10897d40 |
| v_type: | 2 |
| v_rdev: | 0 |
| v_data: | 0x30000231dc8 |
| v_filocks | 0 |
| v_shrlocks: | 0 |
| v_cv: | 0 |
| v_locality: | 0xbaddcafebaddcafe. |

Additionally, any number of arguments can be added to the command to specify which elements of the structure to display. The command:

30000231e58::struct_vnode_tv_data v_op v vfsp

will display the following:

--------struct_vnode@0×30000231e58 v_data v op v_vfsp --------

| | |
|---|---|
| v_op: | 0x104609f8 |
| v_data: | 0x30000231dc8 |
| v_vfsp: | 0x1043f4e0. |

Another option available to the operator or debugger will create a “walker” file to walk through a linked list or other data structure. To use this option, the operator generates a walker file that has the format <name>:<pointer name>:<end conditon>, where <name> is the name of the structure to walk, <pointer name> is the name of the linking pointer in the structure, and <end condition> is the condition which will terminate the walker, typically, a NULL pointer. An example of a walker file, wfile, might include the following lines:

page_t:p_next:NULL:

page_t:p_hash:NULL:

page_t:p_vpnext:NULL:.

The command:

mdbgen -f/usr/include/sys/vnode.h, /usr/include/vm/page.h -w wfile will create the necessary code to walk the lists as described in wfile. In order to walk the p_hash list within page_t, the operator would enter a command such as:

0×10897d40::walk page_t_phash.

In response, the system would respond with the location of elements of the linked list starting at address 0×10897d40. A possible output is:

10897d40

107355c0

10884ae0

---------- 3 Entries.

To display the full contents of the data structure being walked, the operator can enter the command:

0×10897d40::walk page_t_p_dcmd.

The system responds with the full content of each node within the linked list. As an example, the system might respond with:

-------struct_page@×10897d40--------

| p_vnode: | 0x30000231e58 |
|---|---|
| p_hash: | 0x107355c0 |
| p_vpnext: | 0x10897d40 |
| p_vpprev: | 0x10897d40 |
| p_next: | 0x10897d40 |
| p_prev: | 0x10897d40 |
| p_offset: | 0 |
| p_selock: | 0 |

| | |
|---|---|
| p_lckcnt: | 0 |
| p_cowcnt: | 0 |
| p_cv: | 0 |
| p_io_cv: | 0 |
| p_iolock_state: | 0 |
| p_filler: | 0 |
| p_fsdata: | 0 |
| p_state: | 0 |

-------struct_page@0×107355c0------

| p_vnode: | 0x3000102a0c8 |
|---|---|
| p_hash: | 0x10884ae0 |
| p_vpnext: | 0x108fe460 |
| p_vpprev: | 0x10920d80 |
| p_next: | 0x107355c0 |
| p_prev: | 0x107355c0 |
| p_offset: | 0x3ed000 |
| p_selock: | 0 |
| p_lckcnt: | 0 |
| p_cowcnt: | 0 |
| p_cv: | 0 |
| p_io_cv: | 0 |
| p_iolock_state: | 0 |
| p_filler: | 0 |
| p_fsdata: | 0 |
| p_state: | 0 |

-------strut_page@0×10884ae0--------

| p_vnode: | 0x1041a830 |
|---|---|
| p_hash: | 0 |
| p_vpnext: | 0x1087afa0 |
| p_vpprev: | 0x10884b40 |
| p_next: | 0x10884ae0 |
| p_prev: | 0x10884ae0 |
| p_offset: | 0x30000bb2000 |
| p_selock: | 1 |
| p_lckcnt: | 0 |
| p_cowcnt: | 0 |
| p_cv: | 0 |
| p_io_cv: | 0 |
| p_iolock_state: | 0 |
| p_filler: | 0 |
| p_fsdata: | 0 |
| p_state: | 0 |

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method to facilitate debugging computer code within an operating system kernel, comprising:
receiving a source file containing a data structure definition;
searching the source file for the data structure definition;
upon finding the data structure definition, saving the data structure definition in a storage structure;
generating a new source code to display a data structure, wherein the new source code is created using the data structure definition;
compiling the new source code into an executable module;
installing the executable module into a modular debugger; and
during execution of the modular debugger, displaying a content of the data structure to a user of the modular debugger using the executable module, whereby the user is able to view the content of the data structure.

2. The method of claim 1, wherein receiving the source file includes receiving a plurality of source files.

3. The method of claim 1, wherein the source file contains a plurality of data structures.

4. The method of claim 3, wherein saving the data structure definition in the storage structure includes saving the plurality of data structures in the storage structure.

5. The method of claim 3, wherein generating the new source code includes:
examining the plurality of data structures in the storage structure to locate a cross-reference between data structures; and
generating the new source code for the plurality of data structures.

6. The method of claim 5, wherein generating the new source code includes generating source code to walk a linked list of data structures.

7. The method of claim 6, wherein displaying the content of the data structure includes displaying the content of the linked list of data structures.

8. The method of claim 1, wherein the data structure definition includes one of a tree, a linked list, a doubly linked list, and a queue.

9. A computer-readable storage medium storing instructions that when executed by a computer cause the computer to perform a method to facilitate debugging computer code within an operating system kernel, the method comprising:
receiving a source file containing a data structure definition;
searching the source file for the data structure definition;
upon finding the data structure definition, saving the data structure definition in a storage structure;
generating a new source code to display a data structure, wherein the new source code is created using the data structure definition;
compiling the new source code into an executable module;
installing the executable module into a modular debugger; and
during execution of the modular debugger, displaying a content of the data structure to a user of the modular debugger using the executable module, whereby the user is able to view the content of the data structure.

10. The computer-readable storage medium of claim 9, wherein receiving the source file includes receiving a plurality of source files.

11. The computer-readable storage medium of claim 9, wherein the source file contains a plurality of data structures.

12. The computer-readable storage medium of claim 11, wherein saving the data structure definition in the storage structure includes saving the plurality of data structures in the storage structure.

13. The computer-readable storage medium of claim 11, wherein generating the new source code includes:
examining the plurality of data structures in the storage structure to locate a cross-reference between data structures; and
generating the new source code for the plurality of data structures.

14. The computer-readable storage medium of claim 13, wherein generating the new source code includes generating source code to walk a linked list of data structures.

15. The computer-readable storage medium of claim 14, wherein displaying the content of the data structure includes displaying the content of the linked list of data structures.

16. The computer-readable storage medium of claim 9, wherein the data structure definition includes one of a tree, a linked list, a doubly linked list, and a queue.

17. An apparatus to facilitate debugging computer code within an operating system kernel, comprising:
a receiving mechanism that is configured to receive a source file containing a data structure definition;
a search mechanism that is configured to search the source file for the data structure definition;
a saving mechanism that is configured to save the data structure definition in a storage structure;
a generating mechanism that is configured to generate a new source code to display a data structure, wherein the new source code is created using the data structure definition;
a compiling mechanism that is configured to compile the new source code into an executable module;
an installing mechanism that is configured to install the executable module into a modular debugger; and
a displaying mechanism that is configured to display a content of the data structure to a user of the modular debugger using the executable module, whereby the user is able to view the content of the data structure.

18. The apparatus of claim 17, wherein the receiving mechanism is further configured to receive a plurality of source files.

19. The apparatus of claim 17, wherein the search mechanism is further configured to search the source file for a plurality of data structures.

20. The apparatus of claim 19, wherein the saving mechanism is further configured to save the plurality of data structures in the storage structure.

21. The apparatus of claim 19, further comprising:
an examining mechanism that is configured to examine the plurality of data structures in the storage structure to locate a cross-reference between data structures; and
wherein the generating mechanism is further configured to generate the new source code for the plurality of data structures.

22. The apparatus of claim 21, wherein the generating mechanism is further configured to generate source code to walk a linked list of data structures.

23. The apparatus of claim 22, wherein the displaying mechanism is further configured to display the content of the linked list of data structures.

24. The apparatus of claim 17, wherein the data structure definition includes one of a tree, a linked list, a doubly linked list, and a queue.
